(19) United States
(12) Patent Application Publication
(10) Pub. No.: US 2007/0111172 A1
(43) Pub. Date: May 17, 2007

(54) Method and apparatus for creating rigorous mathematical thinking

(76) Inventor: James Kinard, Chicago, IL (US)

Correspondence Address: WELSH & KATZ, LTD, 120 S RIVERSIDE PLAZA, 22ND FLOOR, CHICAGO, IL, 60606, US

(21) Appl. No.: 11/584,367

(22) Filed: Oct. 20, 2006

Related U.S. Application Data
(60) Provisional application No. 60/728,832, filed on Oct. 21, 2005.

(51) Int. Cl. G09B 19/02

(52) U.S. Cl. 434/188

(57) ABSTRACT

A method and apparatus are provided for teaching rigorous mathematical thinking to a learner. The method includes the steps of mediating the learner to appropriate a set of cognitive tasks as general physiological tools based upon their structure-function relationship, mediating the learner to perform the set of cognitive tasks through the use of the physiological tools to construct higher-order cognitive processes, mediating the learner to systemically build basic essential concepts needed in mathematics from everyday experiences and language, mediating the learner to discover and formulate the mathematical patterns and relationships in the cognitive processes, mediating the learner to appropriate mathematically specific psychological tools based upon their unique structure-function relationships and mediating the learner to practice the use of each mathematically specific psychological tool to organize and orchestrate the use of cognitive functions and to construct mathematical conceptual understanding.

This application is a continuation-in-part of U.S. Provisional Patent Application No. 60/728,832 filed on Oct. 21, 2005.

### FIELD OF THE INVENTION

The invention has to do with methods of teaching and more particularly, to methods of teaching rigorous mathematical thinking.

### BACKGROUND OF THE INVENTION

There is a growing concern in the U.S. that American mathematics and science education is falling behind that of other industrialized societies. This is manifested in poor performance and low academic achievement in mathematics and science for the vast majority of America's students, generally compared with students in other Western and industrialized Asian countries. Mathematics and science education are seen as cornerstones of adequate functioning in a technological society. The lack of rigorous thinking and problem solving skills in students, particularly with reference to the content of instruction, is a frequently identified concern. Simply learning calculations and mechanical processes, without understanding and manipulating the deeper structures of thinking, is clearly not sufficient for competence.

At least one reference asserts that part of the reason for this situation is because children are required to learn arithmetic before they even know the meaning of numbers. Another reference asserts that it is critical for children to begin engaging in rigorous mathematical concepts from an early age.

The need for rigorous mathematical thinking was clearly revealed in a study of the work of eighth graders as part of the Third International Mathematics and Science Study (TIMSS). TIMSS data shows that U.S. eighth grade students scored below their peers from 27 nations in mathematics and below their peers from 16 nations in science. Japanese students scored well above German and U.S. students, while German students moderately out-performed U.S. students. Because of the importance of education, a need exists for better methods of educating children.

### SUMMARY

A method and apparatus are provided for teaching rigorous mathematical thinking to a learner. The method includes the steps of mediating the learner to appropriate a set of cognitive tasks as general physiological tools based upon their structure-function relationship, mediating the learner to perform the set of cognitive tasks through the use of the physiological tools to construct higher-order cognitive processes, mediating the learner to systemically build basic essential concepts needed in mathematics from everyday experiences and language, mediating the learner to discover and formulate the mathematical patterns and relationships in the cognitive processes, mediating the learner to appropriate mathematically specific psychological tools based upon their unique structure-function relationships and mediating the learner to practice the use of each mathematically specific psychological tool to organize and orchestrate the use of cognitive functions and to construct mathematical conceptual understanding.

### BRIEF DESCRIPTION OF THE DRAWINGS

FIG. 1 depicts interaction between an instructor and learner using a set of learning materials in accordance with an illustrated embodiment of the invention;

FIG. 2 depicts the materials of FIG. 1 in the case of a sequential relationship;

FIG. 3 depicts the steps of FIG. 1 under an alternate embodiment involving a progression;

FIG. 4 depicts the steps of the FIG. 1 under still another embodiment using triangles and a square;

FIG. 5 depicts the steps of the FIG. 1 under still another embodiment using a functional relationship;

FIG. 6 depicts the steps of the FIG. 1 under still another embodiment using a functional relationship;

FIG. 7 depicts the steps of the FIG. 1 under still another embodiment using an equation;

FIG. 8 depicts the steps of FIG. 1 under still another embodiment involving a whole and its parts; and

FIG. 9 depicts the steps of FIG. 1 of cognitive developement.

### DETAILED DESCRIPTION OF AN ILLUSTRATED EMBODIMENT

As used herein rigorous mathematical thinking is defined as the synthesis and utilization of mental operations to: 1) derive insights in the mind of a person (i.e., learner) about patterns and relationships; 2) apply culturally derived devices and schemes to further elaborate these insights for their organization, correlation, orchestration and abstract representation to form emerging conceptualizations and understandings; 3) transform and generalize these emerging conceptualizations and understandings into coherent, logically-bound ideas and networks of ideas; 4) engineer the use of these ideas to facilitate problem-solving and the derivations of other novel insights in various contexts and fields of human activity; and, 5) perform critical examination, analysis, introspection, and ongoing monitoring of the structures, operations, and processes of rigorous mathematical thinking for its radical self-understanding and its own intrinsic integrity. It should be specifically noted, that the process described herein is not drawn to the mental steps of mathematical thinking itself; but, instead, to the process and apparatus that produce the end result of rigorous mathematical thinking.

A construct of this theory is that rigorous mathematical thinking is a dynamic that structures a logical framework and an organizing propensity for numerous socio-cultural endeavors through its discovery, definition, and orchestration of those qualitative and quantitative aspects of objects and events in nature and human activity. The enigma of the apparent universal intrinsic pervasiveness of order, structure, and change is continuously intriguing. It is through mathematical thinking that the human mind can attempt to discover and characterize underlying order in the face of chaos; structure in the midst of fragmentation, isolation, and incoherency; and, dynamic change in the context of constancy and steady-state behavior. Mathematical thinking structures and creatively manipulates growing systems of thought as change, order, and structure are defined and uniquely moved through a process of conceptualizing to depict and understand evident and underlying patterns and relationships for each situation under examination.

Mathematics is the study of patterns and relationships. In modern mathematics, such study is facilitated by culturally derived devices and schemes that were constructed through and are driven by the mathematical thinking dynamic. These culturally derived devices and schemes are synonymous with Vygotsky's conceptualization of psychological “tools” (see Kozulin, Psychological Tools, 1998). Kozulin, in elaborating on Vygotsky's conceptualization, stated, “Psychological tools are symbolic artifacts—signs, symbols, texts, formulae, graphic-symbolic devices—that help us master our own ‘natural’ psychological functions of perception, memory, attention, will, etc.” (Kozulin, 1998).

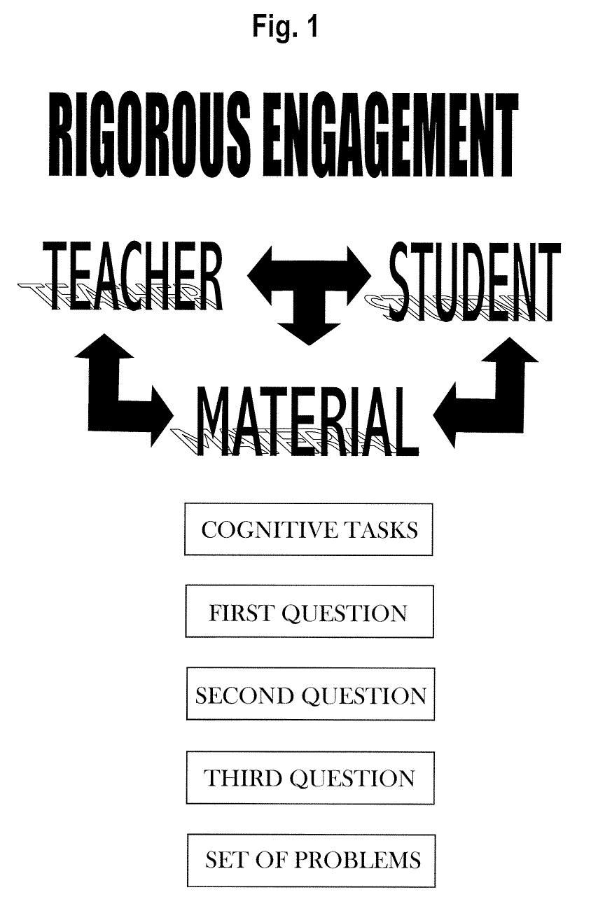

Symbolic devices and schemes that have been developed through socio-cultural needs in order to facilitate mental activity dealing with patterns and relationships are mathematical psychological tools. The structuring of these tools has slowly evolved over periods of time through collective, generalized purposes of the transitioning needs of the transforming cultures (see, for example, Eves, An Introduction to the History of Mathematics). Both the creation of such tools and their utilization develop, solicit, and further elaborate higher-order mental processing that characterizes the mathematical thinking dynamic (see FIG. 1). Mathematical psychological tools range from simple forms of symbolization such as numbers and signs in arithmetic to the complex notations and symbolizations that appear in calculus and mathematical physics such as differential equations, integral functions or Laplace Transforms. Mental operations that are synthesized, orchestrated and applied which characterize mathematical thinking are presented in Table 1. Evidence of the logical framework and organization of modern mathematics is reflected through both the hierarchal nature of its system of psychological tools and sub-disciplines and the progressive embodiment of the conceptualization process from simple arithmetic through mathematical physics.

Mathematics, with its system of psychological tools and mathematical thinking dynamic, is the primary language for basic and applied science. Language provides the vehicle for the formulation, organization, and articulation of human thought. Science is a way of knowing—a process of investigating, observing, thinking, experimenting, and validating. This way of knowing is the application of human intelligence to produce interconnected and validated ideas about how the physical, biological, psychological, and social worlds work (American Association for the Advancement of Science, 1993). Scientific thought processes comprise cognitive functions, mental operations, and emerging conceptualizations associated with this way of knowing to understand the world around us. The psychological tools of mathematics and the mathematical thinking dynamic provide the vehicle and energizing element to promote the processes of representation, synthesis and articulation—a language for scientific thought at the receptive, expressive, and elaborational levels. The American Association for the Advancement of Science states in Science for all Americans (1990) that “mathematics provides the grammar of science—the rules for analyzing scientific ideas and data rigorously.”

TABLE 1
Mental Operations that Characterize Mathematical Thinking

Abstract relational thinking
Structural analysis
Operational analysis
Representation
Projection of virtual relationships
Inferential-hypothetical thinking
Deduction
Induction
Differentiation
Integration
Reflective thinking with elaboration of cognitive categories
Conservation of constancy in the context of dynamic
change

Since mathematical thinking synthesizes and utilizes a spectrum of cognitive processing that advances onto higher and higher levels of abstraction, it has to be rigorous by its very nature. In general, rigor may be delineated into a number of elements. The fundamental elements of rigor include: 1) sharpness in focus and perception; 2) clarity and completeness in definition, conceptualization, and delineation of critical attributes; and 3) precision and accuracy.

Rigor may also include a number of systemic elements. The systemic elements of rigor include: 1) critical inquiry and intense searching for truth (logical evidence of reality) and 2) intensive and aggressive mental engagement that dynamically seeks to create and sustain a higher quality of thought

Rigor may also include a number of higher-order superstructures. The higher-order superstructures include: 1) a mindset for critical engagement and 2) a state of vigilance that is driven by a strong, persistent, and inflexible desire to know and deeply understand.

The high level of abstraction, logical integrity, and organizing propensity of mathematical thinking imbue it with an overarching usefulness and applicability that pervades and drives numerous fields of human endeavors including natural and social sciences, agriculture, art, business, engineering, history, industry, medicine, music, politics, sports, etc. The dependency of science on mathematical thinking was voiced by Plato around 390 B.C.: “ . . . that the reality which scientific thought is seeking must be expressible in mathematical terms, mathematics being the most precise and definite kind of thinking of which we are capable. The significance of this idea for the development of science from the first beginnings to the present day has been immense.”

Rigorous mathematical thinking may also include a second theoretical construct. The second theoretical construct is that rigorous mathematical thinking engineers and formulates higher-order conceptual tools that produce scientific thinking and scientific conceptual development.

Rigorous mathematical thinking may also include a third theoretical construct. The third theoretical construct is that the constructs of the theory are operationalized through a paradigm that consists of MLE and FIE, along with a unique blend of the operational concept of rigorous thinking (Kinard and Falik, 1999), the appropriation of culturally derived psychological tools as described by Kozulin (1998), and Ben-Hur's model of concept development (1999).

Creation of rigorous mathematical thinking (RMT) and mathematical-scientific conceptual development is structured and realized through rigorous engagements with patterns and relationships (see FIG. 1). The structuring and maintenance of the engagement may be engineered through MLE. Professor Reuven Feuerstein defines MLE as a quality or modality of learning that requires a human mediator who guides and nurtures the mediatee (learner) using three central criteria (intentionality/reciprocity, transcendence, and meaning) and other criteria that are situational (Feuerstein and Feuerstein, 1991). The learner is mediated while utilizing the comprehensive and highly systematic sets of psychological tools of the FIE program to begin realizing the six subgoals of the program: correction of deficient cognitive functions; acquisition of basic concepts, labels, vocabulary, operations, and concepts necessary for FIE; production of intrinsic motivation through habit formation; creation of task-intrinsic motivation; development of insight and reflection; and, transformation of the learner's role into one of an active generator of new information.

During the realization of these subgoals many of the psychological tools of the FIE program are appropriated as mathematical psychological tools, as delineated by Kozulin (1998), using the MLE central criteria. As the learner acquires and utilizes these mathematical psychological tools to generate, transform, represent, manipulate, and apply insights derived from patterns and relationships, rigorous mathematical thinking is created. As mathematical thinking is unfolding, the learner is rigorously mediated to utilize his/her day-to-day perceptions and spontaneous concepts to construct mathematical concepts. During the process the learner is mediated to utilize his/her mathematical thinking and conceptualizing to formulate scientific conceptual tools to build higher-order scientific thinking and science concepts.

The FIE program provides rich avenues through which concept development can emerge within the learner according to the five principles of mediation practice described by Ben-Hur (1999). These five principles are: practice, both in terms of quantity and quality; decontextualization; meaning; recontextualization; and, realization.

The interactions developed through rigor are dynamic (exciting, challenging, and invigorating), interdependent, and transformative. When these bidirectional interactions permeate each other to produce dynamic reversibility throughout the channels of interaction, rigorous engagement has been initiated.

RMT is a unique embodiment of the inventor's cognitive conceptual construction approach based upon Feuerstein's theory of Mediated Learning Experience and his practice of IE (FIE/MLE), and Vygotsky's sociocultural theory, particularly his concept of psychological tools. IE was designed to develop general thinking and learning how to learn skills, while Vygotsky's concept of psychological tools is designed to transform basic psychological processes into higher psychological processes. While the RMT paradigm could be compatible with any cognitive program, based on research and practice of the learning sciences FIE/MLE is the most comprehensive, systemically structured and coherent cognitive program available.

The goal of RMT is to equip the learner with the capacity and motivation to construct and apply deep mathematical conceptual understanding.

The described concepts of RMT offer a number of advantages. For example, RMT defines mathematics as a unique culture with its own belief system, language, and ways of doing things that is distinctively different from the mores of various societies and cultures. Thus, mathematics education involves a process of imbuing learners with a new culture that is different from the beliefs, values, and norms that are imprinted in learners' typical dispositions and everyday activities.

RMT also transforms the models in IE or other cognitive tasks to psychological tools. RMT formulates mathematical patterns and relationships in the IE pages or other cognitive exercises. RMT systemically builds basic concepts needed in mathematics from everyday experiences and language and introduces the concept of mathematically specific psychological tools. RMT develops a process of transforming everyday language into mathematical language as a mathematically specific psychological tool. RMT creates new mathematically specific cognitive functions and develops the process of cognitive conceptual construction.

The practice of RMT will be discussed next. The practice of RMT focuses on mediating the learner in constructing robust cognitive processes while concomitantly building mathematical concepts using the three-phase, six-step process shown below.

Phase I: Cognitive Development

1) The learner is mediated to appropriate the models in IE or other cognitive tasks as general psychological tools based on their structure-function relationship.

2) The learner is mediated to perform IE or other cognitive tasks through the use of the psychological tools to construct higher-order cognitive processes.

Phase II: Content As Process Development

3) The learner is mediated to systemically build basic essential concepts needed in mathematics from everyday experiences and language;

4) The learner is mediated to discover and formulate the mathematical patterns and relationships in the IE pages or other cognitive exercises.

5) The learner is mediated to appropriate mathematically specific psychological tools, i.e. number system with place values, number line, table, x-y coordinate plane, mathematical language, etc., based on their unique structure-function relationships.

Phase III: Cognitive Conceptual Construction Practice

6) The learner is meditated to practice the use of each mathematically specific psychological tool to organize and orchestrate the use of cognitive functions to construct mathematical conceptual understanding.

During the entire process, the quality of rigor must continuously emerge and be maintained. The RMT invention defines mathematical rigor as that quality of thought that reveals itself when learners are engaged through a state of vigilance—driven by a strong, persistent, and inflexible desire to know and deeply understand. When this rigor is achieved, the learner is capable of functioning both in the immediate proximity as well as at some distance from the direct experience of the world, and has an insight into the learning process, which has been described as metacognitive. This quality of engagement compels intellectual diligence, critical inquiry, and intense searching for truth—addressing the deep need to know and understand.

Rigorous mathematical thinking in the learner is characterized by two major components: 1) the disposition of a rigorous thinker—being relentless in the face of challenge and complexity, and having the motivation and self-discipline to persevere through a goal-oriented struggle. It also requires an intensive and aggressive mental engagement that dynamically seeks to create and sustain a higher quality of thought; and 2) the qualities of a rigorous thinker—initiated and cultivated through mental processes, that engender and perpetuate the need for the engagement in thinking. The qualities of a rigorous thinker are dynamic in nature and include: a sharpness in focus and perception; clarity and completeness in definition, conceptualization, and delineation of critical attributes; precision and accuracy; and, depth of comprehension and understanding.

Table 2 provides the reader with a set of terms used herein and the intended meaning to be given to each term.

TABLE 2

| | |
|---|---|
| 1. | Appropriate - to take as one's own; to seize for one's personal gain. |
| 2. | Cognitive - thinking; mental. |
| 3. | Cognitive function - a specific thinking action; a mental process that has a |
| | specific meaning. |
| 4. | Culture - a collection and system of interactions of beliefs, values, customs, |
| | rituals, tools, language, “ways of doing things”, etc. by a group of people who |
| | share membership based on some factor or group of factors, such as religious or |
| | social proclivity, interest, occupation, geographical contiguity, etc. |
| 5. | Higher-order cognitive processes - cognitive functions that are more abstract in |
| | nature and demand a high level of mental organization and rigor when being used. |
| 6. | Mathematically-specific cognitive functions - specific thinking actions that are |
| | needed to deal directly with the abstractions and generalizations of mathematical |
| | stimuli. |
| 7. | Mathematically-specific psychological tools - mathematical symbols, signs, and |
| | artifacts such as equations, formulas, tables, coordinate planes, number lines, etc., |
| | each having its own unique structure-function relationship to produce |
| | mathematical conceptual understanding. |
| 8. | Mediate - To be intentional and obtain meaningful response from the learner by |
| | guiding, shaping, scaffolding, nurturing, encouraging, etc. |
| 9. | Model - an example for imitation or emulation; a pattern for something to be |
| | made. |
| 10. | Metacognitive - thinking about or reflecting on one's thinking. |
| 11. | Psychological tools - signs, symbols or artifacts that have a particular meaning in |
| | one's culture and society. |
| 12. | Vigilance - paying close attention; watchfulness, alertness. |

Following in Table 3 is a generalized description of three levels of cognitive functions for RMT.

TABLE 3

| | |
|---|---|
| Cognitive Function | Definition |

Level 1 - General Cognitive Functions for Qualitative Thinking

| | |
|---|---|
| 1. Labeling - Visualizing | 1. Giving something a name based on its critical attributes while |
| | forming a picture of it in the mind or producing an internalized |
| | construction of an object when its name is presented.. |
| 2. Comparing | 2. Looking for similarities and differences between two or more |
| | objects, occurrences, or situations. |
| 3. Searching systematically | 3. Looking in a purposeful, organized, and planful way to collect |
| to gather clear and complete | clear and complete information. |
| information | |
| 4. Using more than one | 4. Mentally working with two or more concepts at one time, such |
| source of information. | as color, size, and shape or examining a situation from more than |
| | one point of view. |
| 5. Encoding-Decoding | 5. Putting meaning into a code (symbol, sign) and/or taking |
| | meaning out of a code. |

Level 2 - Cognitive Functions for Quantitative Thinking with Precision

| | |
|---|---|
| 1. Conserving Constancy | Identifying and describing what stays the same in terms of an |
| | attribute, concept or relationship while some other things are |
| | changing. |
| 2. Quantifying Space and | Using an internal and/or an external system of reference as a |
| Spatial relationships | guide or an integrated guide to organize, analyze, help articulate, |
| | and quantify differentiated, representational space and spatial |
| | relationships based on whole-to-parts relationships. |
| 3. Quantifying Time and | Establishing referents to categorize, quantify, and order time and |
| Temporal relationships | temporal relationships based on whole-to-parts relationships. |
| 4. Analyzing - Integrating | Breaking a whole or decomposing a quantity into its critical |
| | attributes or its composing quantities - constructing a whole by |
| | merging its parts or critical attributes or composing a quantity by |
| | merging other quantities together. |
| 5. Generalizing | Observing and describing the nature or the behavior of an object |
| | or a group of objects without referring to specific details or |
| | critical attributes. |
| 6. Being Precise | Striving to be focused and exact. |

Level 3 - Cognitive Functions for Generalized, Logical Abstract Relational Thinking
in the Mathematics Culture

| | |
|---|---|
| 1. Activating Prior | Mobilizing previously acquired mathematical knowledge by |
| Mathematically Related | searching through past experiences in order to make associations |
| Knowledge | and coordinate aspects of something currently being considered |
| | and aspects of those past experiences. |
| 2. Providing and | Giving supporting details, clues, and proof that make |
| Articulating | mathematical sense to substantiate the validity of a statement, |
| Mathematical Logical | hypothesis or conjecture. Generating conjectures, questions, |
| Evidence | seeking answers, and communicating explanations while |
| | complying with the rule of mathematics and ensuring logical |
| | consistency. |
| 3. Defining the Problem | Looking beneath the surface by analyzing and seeing |
| | relationships to figure out precisely what has to be done |
| | mathematically. |
| 4. Inferential-Hypothetical | Forming a mathematical proposition or hypothesis and searching |
| Thinking | for mathematical logical evidence to support the proposition or |
| | hypothesis or deny it. Developing valid generalizations and based |
| | on a number of mathematical events. |
| 5. Projecting and | Forming connections between seemingly isolated objects or |
| Restructuring | events and reconstructing existing connections between objects |
| Relationships | or events in order ton solve new problems. |
| 6. Forming Proportional | Establishing a quantitative relationship of correspondence |
| Quantitative | between a concept (or a dimension) A and a different concept (or |
| Relationships | a dimension) B or between the same concept in two different |
| | contexts by: 1) determining some original amount of A and a |
| | connecting original amount of B; and, 2) hypothetically testing to |
| | see that for any multiples of the original quantity A the |
| | corresponding quantities of B will result from the same multiples |
| | of the original quantity of B. |

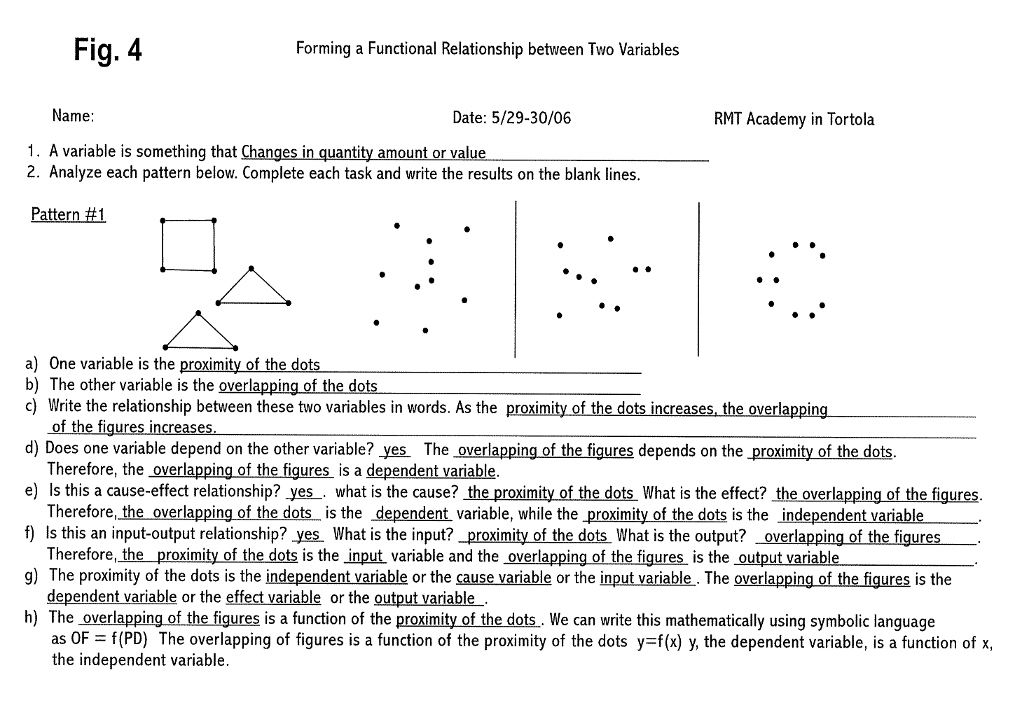

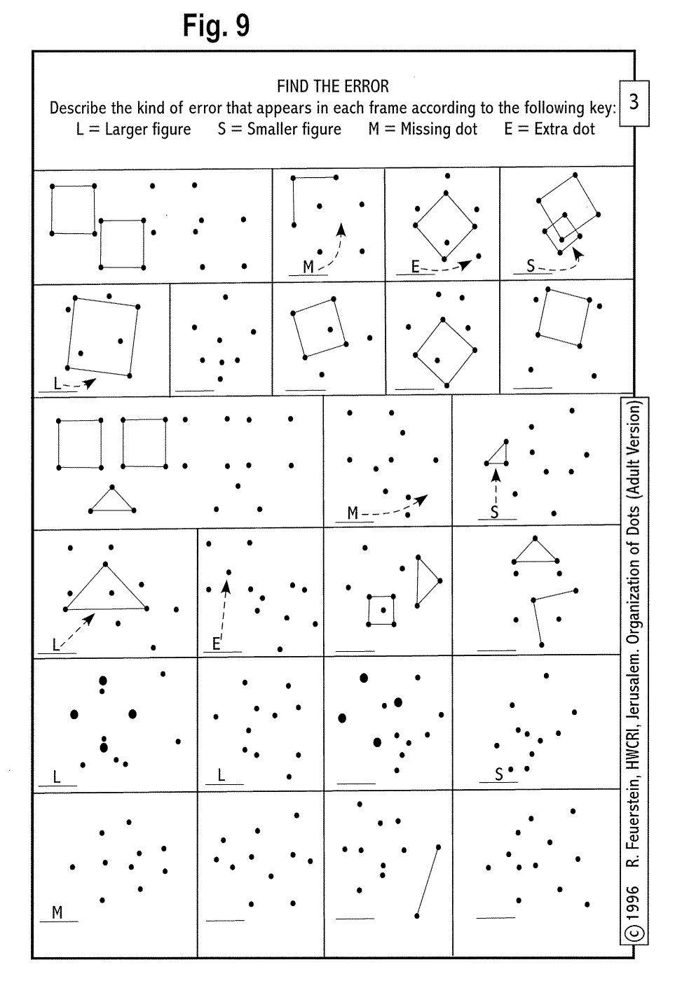

The six examples of FIGS. 4-9 depict ways of implementing portions of the RMT process. FIG. 9 depicts an example problem directed to teaching Cognitive Development (steps 1 and 2) of RMT. FIG. 9 is taken from the Organization of Dots of IE by Feuerstein.

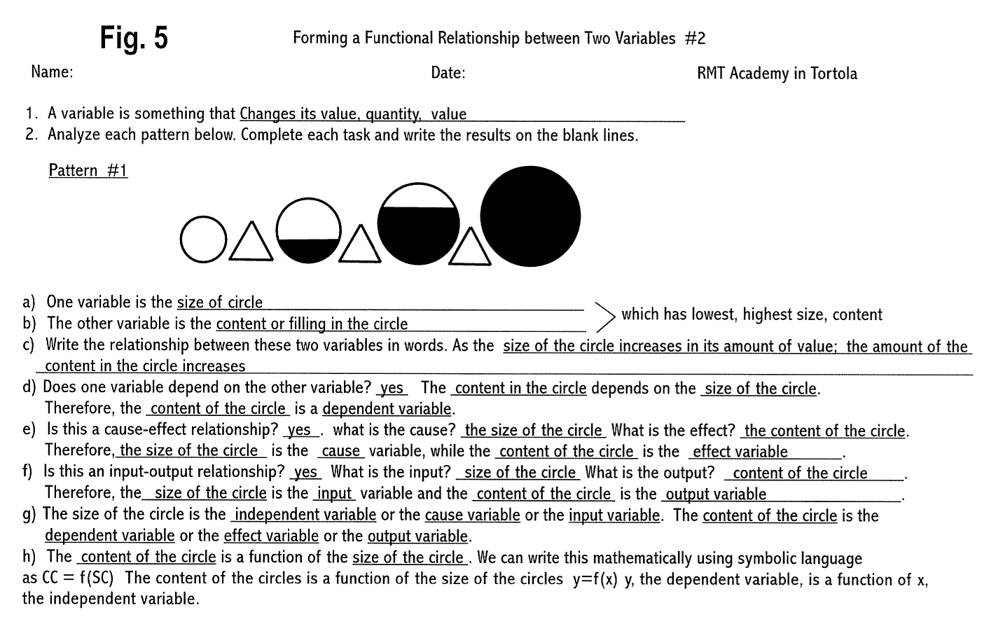

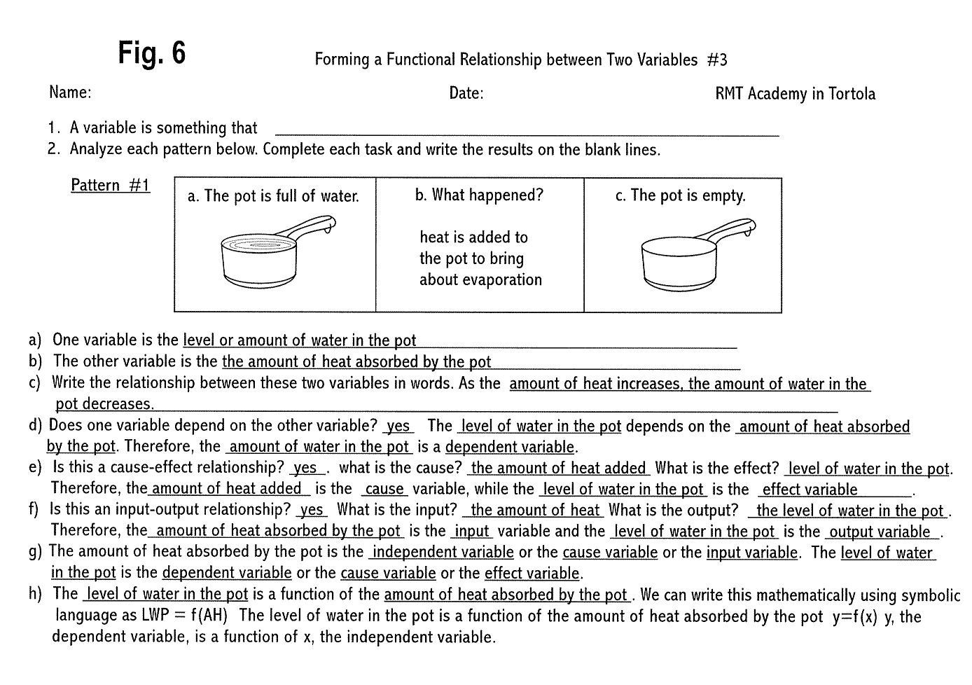

The first three examples (FIGS. 4-6) are directed to subsequent steps of the RMT process. FIGS. 4 and 5 illustrate one type of focus, while the fourth example (FIG. 6) shows a slightly different type of focus.

In each of the sample activities of FIGS. 4-7, the cognitive phase (phase I), can be assumed to have been developed. It should also be noted that mediation of the learner is a complex interaction of the teacher, the learner and the materials. For example, the specific questions of FIGS. 4-7 function as the initial prompt in the mediation of the learner to perform a certain task or develop and achieve some initial intellectual process. Beyond this, the teacher may prompt the learner with corrective or explanatory prompts to further mediate development of the specific intellectual process of the associated step of the RMT process.

FIGS. 4, 5 and 6 provide examples of steps 3-5 of phase II (Content as Process Development). In Step 3, the teacher begins by mediating the learners to define the concept of variable (#1 of the exercise), using their own words. Teacher uses #2 of the exercise to combine Steps 3 and 4 to systematically develop more essential concepts (step 3) through the examination of the cognitive pattern (Step 4) given in each exercise.

Exercises ‘a’ through ‘g’ are used to guide learner practice of Steps 1-4 of the RMT process of practice. Exercise ‘h’ culminates Steps 3 and 4 into an emergence of Step 5—the development of mathematically specific psychological tools—mathematical language, symbols, and formulae, that can then be used for further practice and development required in Step 6. Note: The first three examples in FIGS. 4-6 provide learner practice on the same concept, but in varying modalities.

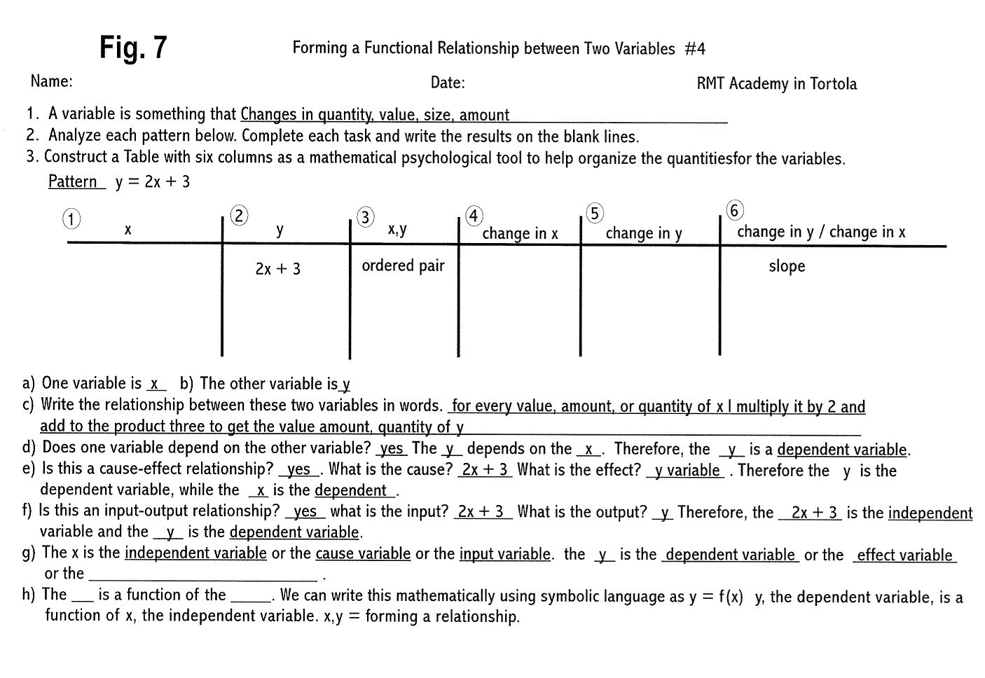

FIG. 7 provides an examples of step 6 of phase III (Cognitive Conceptual Construction Practice). FIG. 7 depicts a more advanced and challenging activity that requires learner mastery of Steps 1-4 and the usage of another mathematically specific psychological tool, (table) which is developed in Step 5, in addition to those that were developed in the previous activities (Examples of FIGS. 4, 5 and 6). The tasks (#'s 1-3 and ‘a’ through ‘h’) in Example 4 (FIG. 7) illustrate the intricate nature of the interaction of mathematically specific psychological tools (Step 5) to problem-solving while concomitantly further developing mathematical language in the context of the mathematics culture.

The first task in Example 4 (FIG. 7) is review for the learner. In the second task, Steps 3 and 4 appear in a more abstract form. A pattern is presented, but is structurally more abstract. The learner must see the formula as a pattern (in which the essential concepts are in a more abstract form because they are implicit). The learner must use his understanding of the cognitive processes developed in Phase one to complete all of the tasks because they are very cognitively demanding and rigorous.

As may be noted, Step 6 (Phase III) subsumes the practice of RMT Cognitive Conceptual Construction.

Table 4 and 5 provides examples of the RMT process under different conditions.

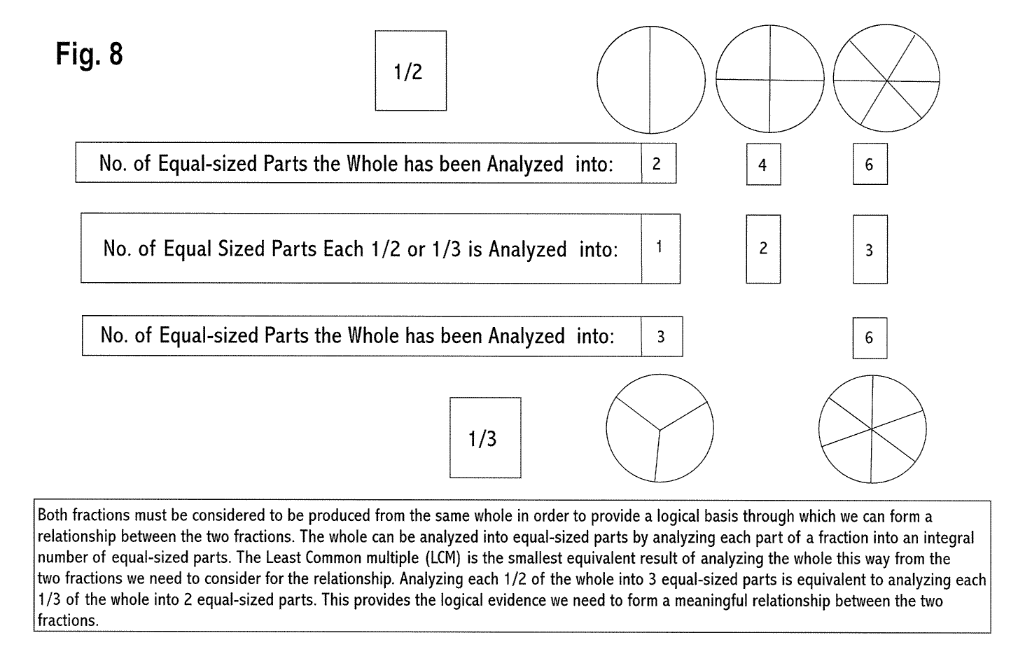

TABLE 4
Examples of the RMT Process
1. Basic Mathematics - Adding fractions of unlike denominators
Add the fractions: ⅓ + ½

| | Sequence of Mathematical | Sequence of Anticipated |
|---|---|---|
| Sequence of RMT Process | Activity Application | RMT Outcomes |
| 1) Appropriate the models | A. Learner studies the | Develop the meaning of the |
| in the cognitive task as | structure of each model | following cognitive |
| general psychological | as a psychological tool | functions from the learner's |
| tools based on their | and performs the | own actions and reflections: |
| structure-function | cognitive task and | labeling-visualizing; |
| relationship. | reflects on the | comparing; searching |
| 2) Perform IE or other | performance of the task. | systematically to gather |
| cognitive tasks through | (What did I do? How | clear and complete |
| the use of the | did I do it? Why did I | information; using more |
| psychological tools to | do it? Could I do it | than one source of |
| construct higher-order | differently?) | information; conserving |
| cognitive processes. | | constancy; analyzing- |
| | | integrating. |
| 3) Systemically build basic | A. Learner studies and | Learner understands that ⅓ |
| essential concepts | reflects on the | means that a whole quantity |
| needed in mathematics | following basic | or amount has been |
| from everyday | essential concepts to | analyzed into three equal- |
| experiences and | doing fractions: whole, | sized parts; the numerator |
| language; | part, quantity and the | tells us that we are |
| | relationships between | considering only one of |
| | these three concepts. | these part, and ½ means that |
| | B. Learner understands | the whole has been analyzed |
| | that a fraction is a part | into two equal-sized parts, |
| | of a whole in terms of | with the numerator |
| | quantity. | considering one of the parts. |
| | C. Learner defines the | Learner also understands |
| | denominator as the | that in order to add ⅓ and |
| | number of equal-sized | ½, the learner must consider |
| | parts the whole has | each fraction to be part of |
| | been analyzed into, | the same whole. |
| | while the numerator is | (See FIG. 8) |
| | defined as the number | |
| | of parts being | |
| | considered at this | |
| | particular time. | |
| | D. Learner realizes that | |
| | when working with two | |
| | or more fractions, the | |
| | same whole must be | |
| | considered to provide | |
| | logical evidence for | |
| | comparing and forming | |
| | any operations among | |
| | these fractions. | |
| 4) Discover and formulate | A. Learner will identify | Learner understands the |
| the mathematical | and define fractions in | practical meaning of |
| patterns and | cognitive tasks and in | fractions. |
| relationships in the IE | everyday experiences | |
| pages or other cognitive | | |
| exercises. | | |
| 5) Appropriate | A. Learner appropriates the | Learner understands that the |
| mathematically specific | meaning of mathematically- | whole is analyzed into three |
| psychological tools, i.e. | specific psychological | equal sized parts for one- |
| number system with place | tools, and is able to | third and must be analyzed |
| values, number line, table, | recognize the | again into two equal-sized |
| x-y coordinate plane, | mathematically-specific | parts for one-half. |
| mathematical language, | psychological tools used to | The learner also understands |
| etc., based on their unique | represent and complete the | that the least common |
| structure-function | content task (adding | multiple (LCM) tells us the |
| relationships. | fractions), such as the real | number of equal-sized parts |
| | number system for quantity | the whole must be |
| | in part/whole relationships, | reanalyzed into in order to |
| | the identity property, | provide the logical evidence |
| | number line, and pictorial | to form a transitive |
| | or figural schema. | relationship between the two |
| | B. Learner activates and | fractions. |
| | recognizes mathematically | The learner now |
| | specific cognitive functions | understands that the |
| | in relation to solving the | common language of the |
| | problem, such as: | whole (CLW) can be |
| | providing and articulating | expressed as: 2/2 = 3/3 = 6/6; |
| | mathematical logical | and the common |
| | evidence, defining the | language of the parts of the |
| | problem, inferential- | whole (CLP) can be |
| | hypothetical thinking, | expressed in the form of the |
| | projecting and restructuring | statements: |
| | relationships, forming | If ⅓ × B = ?/6 and |
| | proportional quantitative | ½ × G = ?/6 |
| | relationships, mathematical | and B = 2/2 and G = 3/3; |
| | transitive relational | then ⅓ = 2/6 and ½ = 3/6; |
| | thinking. | therefore: 2/6 + 3/6 = ⅚ |
| | | (See FIG. 8) |
| 6) Practice the use of each | Learner practices and | Learner internalizes the |
| mathematically specific | reflects on solving | cognitive conceptual |
| psychological tool to | problems involving | construction process for |
| organize and orchestrate the | addition of fractions with | adding fractions with unlike |
| use of cognitive functions to | unlike denominators. | denominators. |
| construct mathematical | | |
| conceptual understanding. | | |

TABLE 5
Examples of the RMT Process
2. Algebraic Concepts - Linear Functions
Linear Function Problem: y = 2x + 3

| | Sequence of Mathematical | Sequence of Anticipated |
|---|---|---|
| Sequence of RMT Process | Activity Application | RMT Outcomes |
| 1) Appropriate the models | a. Learner studies and | a. From learner's own |
| in the cognitive task as | performs cognitive tasks | actions and reflections, |
| general psychological | that identify, define, and | learner activates and |
| tools based on their | develop general | further develops the |
| structure-function | psychological tools and | meaning of cognitive |
| relationship. | their structure-function | functions from levels 1 |
| 2) Perform IE or other | relationship. | and 2 in the cognitive |
| cognitive tasks through | b. From performing the | function list. The |
| the use of the | cognitive tasks, learner | functions help the |
| psychological tools to | identifies and | learner identify and |
| construct higher-order | understands that | define change and |
| cognitive processes. | psychological tools | constancy and |
| | organize unorganized | variability. |
| | stimuli into meaningful | b. Learner develops the |
| | relationships. | ability to use |
| | | psychological tools to |
| | | cluster the cognitive |
| | | functions needed to |
| | | form systems of |
| | | cognitive functions to |
| | | deal with constancy in |
| | | the complexity of |
| | | change. |
| 3) Systemically build basic | B. Learner identifies a | a. Learner develops the |
| essential concepts | series of experiences | ability to identify and |
| needed in mathematics | occurring in daily life | define change and |
| from everyday | that reflect change and | constancy presented |
| experiences and | constancy. | through complex |
| language; | C. In the following two | stimuli. |
| | situations, learner | b. Learner develops |
| | understands that “a” is a | understanding of the |
| | variable because it | dynamic mathematical |
| | changes its value in | concept of variable. |
| | different situations or at | |
| | different times. | |
| | Situation #1: a + 5 = 8 | |
| | Situation #2: a + 12 = 19 | |
| 4) Discover and formulate | A. Learner studies and | a. Learner identifies and |
| the mathematical | observes patterns of | clearly defines the |
| patterns and | change and constancy in | variables in each |
| relationships in the IE | cognitive tasks. | pattern and the part of |
| pages or other cognitive | Examples are: 1) | the pattern that stays |
| exercises. | variations in proximity | constant. |
| | of dots in unorganized | (See FIGS. 4-7) |
| | clouds of dots and | |
| | overlapping of figures, | |
| | while the size and shape | |
| | of figures conserve | |
| | constancy; 2) variations | |
| | in size and content of a | |
| | circle while the shape of | |
| | the circle conserve | |
| | constancy; 3)variations | |
| | in the level of water in a | |
| | pot and the amount of | |
| | heat absorbed by the pot, | |
| | while the pot retains its | |
| | identity. | |
| 5) Appropriate | A. Learner analyzes the | a. Learner understands |
| mathematically specific | structure-function of the | that ‘x’ and ‘y’ are |
| psychological tools, i.e. | algebraic expression | variables because they |
| number system with | y = 2x + 3 and appropriates | change their amounts |
| place values, number | it as a mathematically- | and that the |
| line, table, and x-y | specific psychological | relationship between |
| coordinate plane, | tool. | ‘x’ and ‘y’ is constant. |
| mathematical language, | B. Learner defines the | b. Learner understands |
| etc., based on their | structure-function | that for every value of |
| unique structure- | relationship between the | ‘x’ - the independent |
| function relationships. | two variables ‘x’ and ‘y’ | variable, it must be |
| | and discovers that ‘x’ is | multiplied by two to |
| | the cause, input or | get a product and that |
| | independent variable, | product added to three |
| | while ‘y’ is the effect, | to obtain the |
| | output or dependent | corresponding value or |
| | variable. | ‘y’ - the dependent |
| | C. Learner defines the | variable. |
| | structure of a table as a | c. Learner uses the table |
| | mathematically-specific | to organize the |
| | psychological tool based | corresponding values |
| | on the structure-function | of the independent and |
| | relationship of its | dependent variables |
| | columns and rows. | and forms a functional |
| | D. Learner appropriates the | relationship between |
| | ‘x-y’ coordinate plane as | each pair. |
| | a mathematically- | d. Learner uses the ‘x-y’ |
| | specific psychological | coordinate plane to |
| | tool that is constructed | show the dynamic |
| | of two number lines that | functional relationships |
| | are perpendicular to | between the values of |
| | each other whose | the two variables in a |
| | intersection is labeled | graphical modality. |
| | the point of origin (0, 0). | |
| 6) Practice the use of each | A. Learner practices | a. Learner creates, |
| mathematically specific | analyzing linear | analyzes and |
| psychological tool to | functions as | understand linear |
| organize and orchestrate | mathematically-specific | functions that may |
| the use of cognitive | psychological tools and | exist in mathematical |
| functions to construct | uses the table and ‘x-y’ | stimuli or in real life |
| mathematical conceptual | coordinate plane to | situations. (See FIGS. |
| understanding. | understand and illustrate | 4-7 below). |
| | the behavior and | |
| | functional relationship | |
| | for the independent and | |
| | dependent variable in | |
| | each linear function. | |

Data were produced through pre- and post-cognitive testing, analysis of audio and video taped sessions of the interventions, case studies of students through their journals of reflection, and “talk out loud about your thinking” by students as they performed tasks and solved problems.

A first set of pre and post tests were performed in a logico-verbal modality. Parallel pre- and post-versions of Logical Reasoning-Inference Test, RL-3, developed by Educational Testing Service (Ekstrom, et al., 1976), were administered for each intervention. Each item on the test requires the student to read one or two statements that might appear in a newspaper or popular magazine. The student must choose only one of five statements that represents the most correct conclusion that can be drawn. The student is instructed not to consider information that is not given in the initial statement(s) to draw the most correct conclusion. The student is also advised not to guess, unless he or she can eliminate possible answers to improve the chance of choosing, since incorrectly chosen responses will count against him/her.

Ekstrom et al. (1976 and 1979) defined the cognitive factor involved in this test as “The ability to reason from premise to conclusion, or to evaluate the correctness of a conclusion.” These authors further stated: “Guilford and Cattell (1971) have sometimes called this factor “Logical Evaluation.”

Guilford and Hoepfner (1971) pointed out that what is called for in syllogistic reasoning tasks is not deduction but the ability to evaluate the correctness of the answers presented. This factor can be confounded with verbal reasoning when the level of reading comprehension required is not minimized.

The complexity of this factor has been pointed out by Carroll (1974) who describes it as involving both the retrieval of meanings and of algorithms from long-term memory and then performing serial operations on the materials retrieved. He feels that individual differences on this factor can be related not only to the content and temporal aspects of these operations, but also to the attention which the subject gives to details of the stimulus materials.”

Three FIE-MLE practitioners, first independently and then collectively, analyzed test items on RL-3 for their required use of cognitive functions and operations to be performed successfully by the student. The following is a summary of their work.
“The student must engage in logical reasoning which requires abstract relational thinking at various levels of complexity. The student is required to interrelate data from the statement(s) with data from potential conclusions to ensure total coherency—that is to conserve constancy in relationships and meaning at various levels of complexity and abstraction. The linkage between the sources of information (the statement(s) and the potential conclusion) is established or denied through inferential thinking—a bridge that requires abstract relational hypothetical thinking to construct, with the underlying supports of precision and accuracy. The statement(s) and the conclusion are in a specifics-to-general or general-to-specifics relationship. The student's thinking must conserve relationships and meaning as it transforms their expressions into higher levels of abstraction in order to encompass broader spectra of abstraction and complexity and vice versa.”

The primary cognitive operation required throughout each version of the test is abstract inferential relational thinking with various levels of complexity. This operation's required deductive and/or inductive thinking is created while the student draws from his/her repertoire of prior knowledge to do further relational thinking to provide the logical evidence for the evaluation of the validity of the conclusion. The range of the cognitive functions and operations for the pre-test was comparable with the range for the post-test, although not sequenced item by item.

The test is indeed in a logico-verbal modality with a demand in language use and an embedded requirement of reading comprehension at various levels of abstraction and complexity.

A set of pre and post tests were performed in a figural modality. Parallel pre-and post-versions of Visualization Test, VZ-2, developed by Educational Testing Service (Ekstrom, et al., 1976), were administered. The authors of the test define the cognitive factor as “the ability to manipulate or transform the image of spatial patterns into other arrangements.”

The instrument used in this research is the Paper Folding Test—VZ-2. The student is instructed to imagine the folding of a square piece of paper according to figures drawn to the left of a vertical line with one or two small circles drawn on the last figure to indicate where the paper has been punched through all thicknesses. The student is to decide which of five figures to the right of the vertical line will be the square sheet of paper when it is completely unfolded with a hole or holes in it. The student is admonished not to guess, since a fraction of the number incorrectly chosen will be subtracted from the number marked correctly.

Two FIE-MLE practitioners analyzed each item to determine the cognitive processing required to successfully perform the task and choose the correct answer. A summary of their findings is given below.
“The student must integrate the use of relevant cues and the sequencing of figures to mentally define and restructure the components of the field onto a unified spatial presentation through visualization. There has to be a high level of conservation of constancy in size, shape, orientation, and location in the face of spatial and temporal transitions. The output requires projection of virtual relationships with precision and accuracy. Both the pre- and post-test increase, to the same degree, in difficulty from the first to the last item. The latter items require intensity in conserving constancy with very high levels of novelty, complexity, and abstraction. These items require deep internalization, integration, and structural and operational analyses.”

The pre-tests were administered prior to the initiation of the intervention. The post-tests were administered at 25 hours of intervention. The gain scores were positive for most students on both tests. These results demonstrated that cognitive dysfunctioning is being corrected and the mental operations of abstract relational thinking, inferential-hypothetical thinking, induction, deduction, integration, structural analysis and operational analysis are being developed. These mental operations help to characterize the mathematical thinking dynamic.

A concept and mental operation that is highly fundamental to mathematical thinking is conservation of constancy in the context of dynamic change. The development of this concept and mental operation was initiated from the first sheet of the first instrument (i.e., Organization of Dots) of the FIE program.

The paradigm structures practice for the learner to develop and utilize this concept and operation in the defining, characterizing, transforming, and applying aspects of patterns and relationships through pictorial, figural, numerical, graphical-symbolic, verbal, and logical-verbal modalities. The learner will experience the emerging of each mental operation and each concept through the same rigorous protocol cited above.

A significant concept that has being developed is the nature and types of mathematical functions. Supporting concepts that are being mediated as emerging foundational elements to mathematical functions are: dependent and independent variables; interdependency; relations; patterns; functional relationships; rate; recursion, etc. This paradigm addresses all of the algebra standard for grades 9-12 along with expectations recommended by the National Council of Teachers of Mathematics (2000, see Table 6).

[image]

The concept of a mathematical function begins to emerge when students begin to verbalize their insights. The following is a sampling of student comments that demonstrate these insights.

Student Insights

Student #1: “So when we look back at page 1 of Organization of Dots, the critical attributes of a square are in a functional relationship with each other to form the square.”

Student #2: “Each characteristic of the square, then, is an independent variable.”

Mediator: “Is there another type of variable?”

Student #2: “Yes, the dependent variable, the square itself. The square is a function of its parts and their relationships.”

Student #1: “There is another point now that we are going beneath the surface, trying to go deeper. Sides of the square—the opposite sides are parallel to each other. If I am standing in the center of the square I will be in a lot of parallelism. Where did it come from? The opposite sides. The parallelism is a dependent variable. It depends on the equidistance of the opposite sides. It is a function of these independent variables. There are two functions embedded here—the square and the parallelism.”

The psychological tools of four FIE instruments were utilized by students to create mathematical thinking. The four instruments are: Organization of Dots and Orientation in Space I, Adult Version, Analytic Perception, and Numerical Progressions. The concept of mathematical function with independent and dependent variables was experienced through most pages and through all modalities. Students are beginning to represent higher-order functional relationships—linear, quadratic, and exponential functions—and manipulate them within the rules of logic and relate them in terms of expressing various empirical and scientific realities. They are using mathematical thinking to characterize, quantify, and further understand growth, decay, surface areas and changes in surface areas of, for example, a cube of melting ice, molecular motion, etc. Many are becoming fluid in articulating their thinking through reflection and elaboration of cognitive categories.

It has been found that approximately, 85% of the students develop an appreciation for doing rigorous mathematical thinking. Secondly, most students demonstrate task-intrinsic motivation and a competitive spirit when doing inductive thinking to construct generalizations. When one student was mediating the class to understand why his plan of action worked to perform a task that required mathematical thinking, he said, “use your mental operations to play with the options. Enjoy using your mental processes to create different strategies. Have fun organizing and reorganizing your cognitive functions and operations as you work through the problem.”

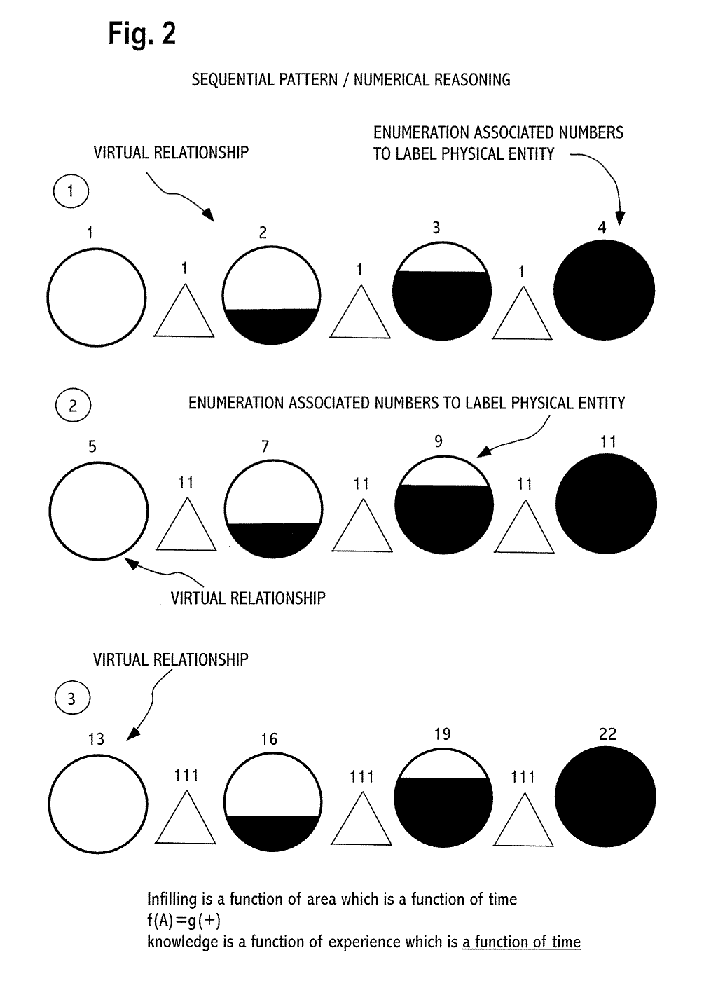

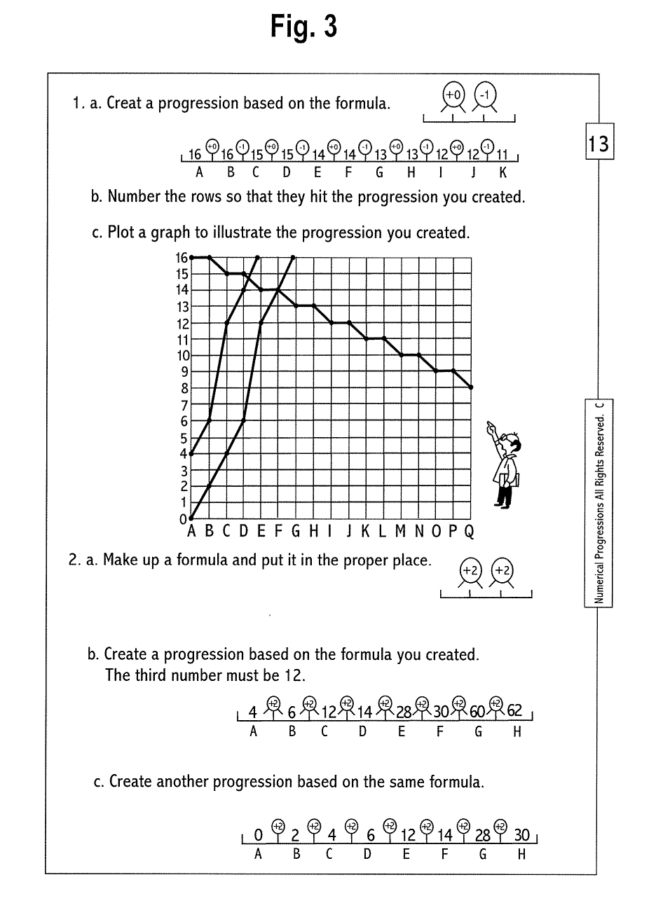

Examples of students' work are presented below and in FIGS. 2 and 3. Just prior to the writing of this paper, students were asked to write their perceptions of mathematical thinking based on their experiences in the class. Following is a collection of some of their responses.
“When you have to synthesize, develop, direct, orchestrate Mental Operations that have inside of them Cognitive Functions. A concept of using Mathematical Terms to solve everyday problems in life. Identify and visualizing at all times. A conscious awareness of issues, complications and processes where you precisely connect the proper mental operations to the issue or equation.”
“Mathematical Thinking: The construction of mental operations to gain in site about a pattern or relationship and represent them by symbols.”
“Mathematical thinking is a serious engagement in developing an analytic perception at all times. It also is a mental operation that helps you gain insight about patterns and relationships.”
“Mathematical thinking is a conscious awareness of issues, complication and processes where you precisely connect the proper mental operations through analytical perception to illustrate the correct answer to the issue or equation. Get the construction of mental operation.”
“Mathematical Thinking is a process using your cognitive functions and sociological tools to apply and figure out tasks that relate to everyday situations as well as equations.”
“Mathematical thinking is the conscious act of relating comparing and finding patterns and sequences of events through numerical symbology, everything has a number. Therefore there must be some law or order underlying it all which can be made into an equation every time to benefit our mental and physical states.”
“Mathematical thinking: In definition, it is similar to an injustice to the concept. Many thoughts come to mind since correlation as we know it is based on mathematical thinking. For example, natural life processes pack, which causes life in a result of mathematical thinking in animate action. The specifics of this process show you how the structure of your inspiratory system and it parts work together in a systematic sequential pattern for you to function. This begins to start cycles which allows one to experience more and develop higher orders of mathematical thinking as one lives.”
“Mathematical Thinking is a group of cognitive functions used to prove thought fundamental and all life related situation deal with laws and actual facts.”

FIG. 2 is a sample of a student's work when doing higher-order mathematical thinking: Developing and transforming insights about relationships between relationships and mathematical functions. Note: This work was produced spontaneously by the student when working on a task far remote to it. It is only though deep structural thinking that such transcendence could be made.

FIG. 3 is an example of a student's work showing how he is using mathematical thinking to traverse modalities (Numerical, Graphical, Logical-verbal) as he does deduction and induction. The student's comments were as follows.
“I was relating the graph, with its horizontal and vertical axis, coordinates and numerical modalities, to a company on the stock market's (Ex. 2-C on Graph) growth within the first 17 months (graph represents profit in $10,000's and also times passed, months). In the first month, you have nothing, you borrow from banks, promoting your product, trying to get investors to invest in your stock, Gain is Break Even to Minimum profit. (A,O) In the second month you make 20,000 profit, and the third and the forth. What we barely realize is that 100% profit is being made in each and every month, though $20,000 profit seems little at the time. But as you have more money to invest, your profit will also, in this case be better.”

A specific embodiment of method and apparatus for teaching rigorous mathematical thinking has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of teaching rigorous mathematical thinking to a learner comprising:
mediating the learner to appropriate a set of cognitive tasks as general physiological tools based upon their structure-function relationship;
mediating the learner to perform the set of cognitive tasks through the use of the physiological tools to construct higher-order cognitive processes;
mediating the learner to systemically build basic essential concepts needed in mathematics from everyday experiences and language;
mediating the learner to discover and formulate the mathematical patterns and relationships in the cognitive processes;
mediating the learner to appropriate mathematically specific psychological tools based upon their unique structure-function relationships; and
mediating the learner to practice the use of each mathematically specific psychological tool to organize and orchestrate the use of cognitive functions and to construct mathematical conceptual understanding.

2. The method of teaching rigorous mathematical thinking as in claim 1 further comprising presenting the learner with a set of geometric figures.

3. The method of teaching rigorous mathematical thinking as in claim 2 further comprising prompting the learner to identify variables within the set of geometric figures.

4. The method of teaching rigorous mathematical thinking as in claim 3 further comprises prompting the learner to identify a relationship among geometric figures of the set of geometric figures.

5. The method of teaching rigorous mathematical thinking as in claim 4 further comprises prompting the learner to determine whether the identified relationship is a cause-effect relationship.

6. The method of teaching rigorous mathematical thinking as in claim 5 further comprises prompting the learner to identify the cause and the effect when the identified relationship is a cause-effect relationship.

7. The method of teaching rigorous mathematical thinking as in claim 4 further comprises prompting the learner to determine whether the identified relationship is an input-output relationship.

8. The method of teaching rigorous mathematical thinking as in claim 7 further comprises prompting the learner to identify the input and the output when the identified relationship is an input-output relationship.

9. The method of teaching rigorous mathematical thinking as in claim 7 further comprising defining dependencies within the set of geometric figures.

10. The method of teaching rigorous mathematical thinking as in claim 1 wherein the step of mediating the learner to discover and formulate the mathematical patterns and relationships in the cognitive processes further comprises prompting the learner with equality as a mathematic concept.

11. The method of teaching rigorous mathematical thinking as in claim 10 wherein the step of prompting the learner with equality as a mathematic concept further comprises disposing constants and variables on opposing sides of an equals sign.

12. The method of teaching rigorous mathematical thinking as in claim 1 wherein the step of mediating the learner to appropriate mathematically specific psychological tools based upon their unique structure-function relationships further comprises prompting the learner with structures of mathematical expression.

13. The method of teaching rigorous mathematical thinking as in claim 1 wherein the structures of mathematical expression further comprise a Cartesian coordinate system.

14. An apparatus for teaching rigorous mathematical thinking to a learner comprising:
means for mediating the learner to appropriate a set of cognitive tasks as general physiological tools based upon their structure-function relationship;
means for mediating the learner to perform the set of cognitive tasks through the use of the physiological tools to construct higher-order cognitive processes;
means for mediating the learner to systemically build basic essential concepts needed in mathematics from everyday experiences and language;
means for mediating the learner to discover and formulate the mathematical patterns and relationships in the cognitive processes;
means for mediating the learner to appropriate mathematically specific psychological tools based upon their unique structure-function relationships; and
means for mediating the learner to practice the use of each mathematically specific psychological tool to organize and orchestrate the use of cognitive functions and to construct mathematical conceptual understanding.

15. The apparatus for teaching rigorous mathematical thinking as in claim 14 further comprising a set of geometric figures that are presented to the learner.

16. The apparatus for teaching rigorous mathematical thinking as in claim 15 further comprising means for prompting the learner to identify variables within the set of geometric figures.

17. The apparatus for teaching rigorous mathematical thinking as in claim 16 further comprises means for prompting the learner to identify a relationship among geometric figures of the set of geometric figures.

18. The apparatus for teaching rigorous mathematical thinking as in claim 17 further comprises means for prompting the learner to determine whether the identified relationship is a cause-effect relationship.

19. The apparatus for teaching rigorous mathematical thinking as in claim 18 further comprises means for prompting the learner to identify the cause and the effect when the identified relationship is a cause-effect relationship.

20. The apparatus for teaching rigorous mathematical thinking as in claim 17 further comprises means for prompting the learner to determine whether the identified relationship is an input-output relationship.

21. The apparatus for teaching rigorous mathematical thinking as in claim 20 further comprises means for prompting the learner to identify the input and the output when the identified relationship is an input-output relationship.

22. An apparatus for teaching rigorous mathematical thinking to a learner comprising:
a set of cognitive tasks appropriated by the learner as general physiological tools based upon their structure-function relationship;
a set of instructions used to mediate the learner to perform the set of cognitive tasks through the use of the physiological tools to construct higher-order cognitive processes;
at least a first question that mediates the learner to systemically build basic essential concepts needed in mathematics from everyday experiences and language;
at least a second question that mediates the learner to discover and formulate the mathematical patterns and relationships in the cognitive processes;
at least a third question that mediates the learner to appropriate mathematically specific psychological tools based upon their unique structure-function relationships; and
a set of problems that mediates the learner to practice the use of each mathematically specific psychological tool to organize and orchestrate the use of cognitive functions and to construct mathematical conceptual understanding.
